(19) United States
(12) Patent Application Publication
(10) Pub. No.: US 2008/0007667 A1
(43) Pub. Date: Jan. 10, 2008

(54) DISPLAY DEVICE

(76) Inventor: Koji Nakayama, Kanazawa-shi (JP)

Correspondence Address: OBLON, SPIVAK, MCCLELLAND MAIER & NEUSTADT, P.C., 1940 DUKE STREET, ALEXANDRIA, VA, 22314, US

(21) Appl. No.: 11/767,701

(22) Filed: Jun. 25, 2007

(30) Foreign Application Priority Data
Jul. 7, 2006 (JP) 2006-188466

(51) Int. Cl. G02F 1/1333

(52) U.S. Cl. 349/54

(57) ABSTRACT

In a display device, an inspection section, which performs an inspection of an active area, includes a first conductive pattern, a second conductive pattern which is spaced apart from the first conductive pattern, and cover patterns which individually cover at least opposed parts of the first conductive pattern and the second conductive pattern and are formed of the same material as a pixel electrode.

### CROSS-REFERENCE TO RELATED APPLICATIONS

This application is based upon and claims the benefit of priority from prior Japanese Patent Application No. 2006-188466, filed Jul. 7, 2006, the entire contents of which are incorporated herein by reference.

### BACKGROUND OF THE INVENTION

1. Field of the Invention

The present invention relates generally to a display device, and more particularly to a display device including an inspection section for performing an inspection relating to quality.

2. Description of the Related Art

A display device, such as a liquid crystal display device, includes an active area that is composed of matrix-arrayed pixels. The active area includes a plurality of scanning lines which extend in a row direction of the pixels, a plurality of signal lines which extend in a column direction of the pixels, switching elements which are disposed near intersections of the scanning lines and signal lines, and pixel electrodes which are connected to the associated switching elements.

Wiring lines, which are connected to the scanning lines and signal lines in the active area, are disposed around the active area. A display device is proposed, in which inspection wiring lines for inspecting wiring defects on a display panel, such as short-circuit or line breakage of such wiring lines as well as short-circuit or line breakage in the active area, are provided on the same display panel (see, e.g. Jpn. Pat. Appln. KOKAI Publication No. 2001-033813).

### BRIEF SUMMARY OF THE INVENTION

The object of the present invention is to provide a display device including an inspection section which can prevent occurrence of defects in a reliability test and a decrease in manufacturing yield.

According to an aspect of the invention, there is provided a display device comprising: an active area including a plurality of pixels each having a pixel electrode, and a plurality of signal supply wiring lines for supplying driving signals to the pixels; and an inspection section which is disposed outside the active area and performs an inspection of the active area, wherein the inspection section includes: a first conductive pattern; a second conductive pattern which is spaced apart from the first conductive pattern; and cover patterns which individually cover at least opposed parts of the first conductive pattern and the second conductive pattern and are formed of the same material as the pixel electrode.

According to this display device, cover patterns which individually cover at least opposed parts of a first conductive pattern and a second conductive pattern that are spaced apart from each other, are disposed, and it is thus possible to prevent damage to these conductive patterns in the inspection section and to prevent short-circuit between the first conductive pattern and second conductive pattern due to the damage. Therefore, it is possible to prevent occurrence of defects in a reliability test and a decrease in manufacturing yield.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 schematically shows the structure of a liquid crystal display panel of a liquid crystal display device according to an embodiment of the present invention;

FIG. 2 schematically shows the structure of an inspection section in the liquid crystal display panel shown in FIG. 1;

FIG. 3 shows an example of the layout of the inspection section shown in FIG. 2; and

FIG. 4 is a cross-sectional view, taken along line A-A in FIG. 3, showing a cross-sectional structure of a switching element in the inspection section shown in FIG. 3.

### DETAILED DESCRIPTION OF THE INVENTION

A display device according to an embodiment of the present invention will now be described with reference to the accompanying drawings.

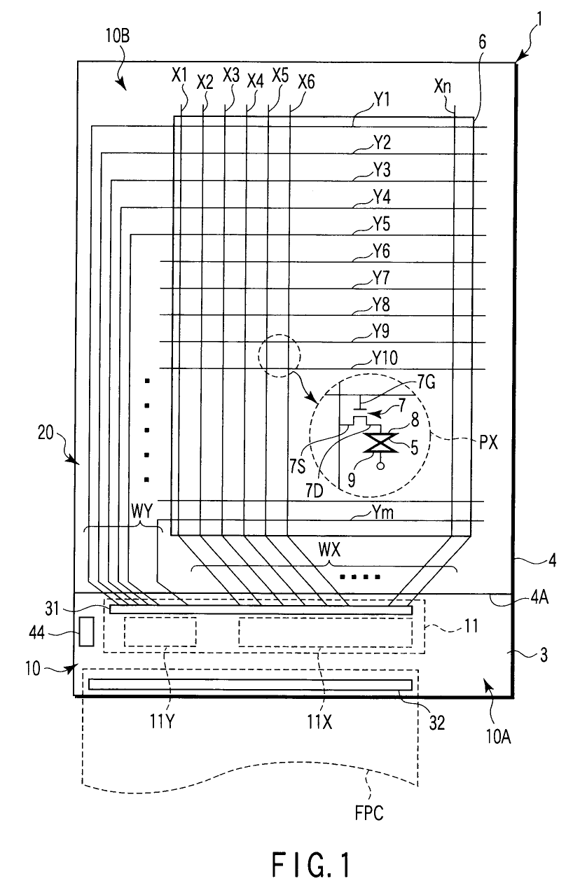

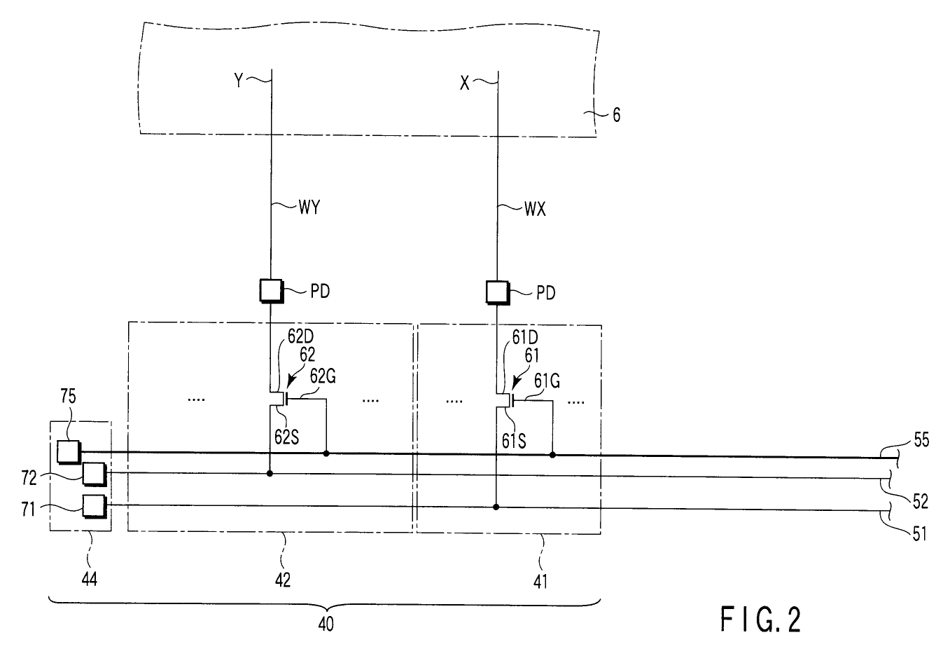

As shown in FIG. 1 and FIG. 2, a liquid crystal display device, which is an example of the display device, includes a substantially rectangular, flat liquid crystal display panel 1. The liquid crystal display panel 1 comprises a pair of substrates, that is, an array substrate 3 and a counter-substrate 4, and a liquid crystal layer 5 that is held between the array substrate 3 and counter-substrate 4 as a light modulation layer. The liquid crystal display panel 1 includes a substantially rectangular active area 6 which displays an image. The active area 6 includes a plurality of pixels PX which are arrayed in a matrix, and a plurality of signal supply wiring lines which supply driving signals to the respective pixels PX.

The array substrate 3 is formed by using a light-transmissive insulating substrate such as a glass substrate. The array substrate 3 includes, as signal supply wiring lines disposed in the active area 6, a plurality of scanning lines Y (1, 2, 3, . . . , m) that extend in a row direction of the pixels PX, and a plurality of signal lines X (1, 2, 3, . . . , n) that extend in a column direction of the pixels PX. The scanning lines Y and signal lines X are disposed on mutually different layers via an insulation layer. In addition, the array substrate 3 includes, in the active area 6, switching elements 7 that are arranged near intersections between scanning lines Y and signal lines X in the respective pixels PX, and pixel electrodes 8 that are connected to the switching elements 7.

The switching element 7 is formed of, e.g. a thin-film transistor (TFT). A gate electrode 7G of the switching element 7 is electrically connected to the associated scanning line Y (or formed integral with the scanning line Y). A source electrode 7S of the switching element 7 is put in contact with a source region of a semiconductor layer and is electrically connected to the associated signal line X (or formed integral with the signal line X). A drain electrode 7D of the switching element 7 is put in contact with a drain region of the semiconductor layer.

The pixel electrode 8 is electrically connected to the drain electrode 7D. In a transmissive liquid crystal display panel which displays an image by selectively passing backlight, the pixel electrode 8 is formed of a light-transmissive metallic material such as indium tin oxide (ITO). On the other hand, in a reflective liquid crystal display panel which displays an image by selectively reflecting ambient light that is incident from the counter-substrate 4 side, the pixel electrode 8 is formed of a light-reflective metallic material such as aluminum (Al). At least the surface of the active area 6 of the array substrate 3 having the above-described structure is covered with an alignment film.

The counter-substrate 4 is formed by using a light-transmissive insulating substrate such as a glass substrate. In the active area 6, the counter-substrate 4 includes a counter-electrode 9 which is common to all pixels PX. The counter-electrode 9 is formed of a light-transmissive metallic material such as ITO. At least the surface of the active area 6 of the counter-substrate 4 having the above-described structure is covered with an alignment film.

The array substrate 3 and counter-substrate 4 are disposed in the state in which the pixel electrodes 8 of all pixels PX are opposed to the counter-electrode 9, and a gap is formed between the array substrate 3 and counter-substrate 4. The liquid crystal layer 5 is formed of a liquid crystal composition which is sealed in the gap between the array substrate 3 and counter-substrate 4.

In a color display type liquid crystal display device, the liquid crystal display panel 1 includes a plurality of kinds of pixels, for instance, a red pixel that displays red (R), a green pixel that displays green (G), and a blue pixel that displays blue (B). Specifically, the red pixel includes a red color filter that passes light with a principal wavelength of red. The green pixel includes a green color filter that passes light with a principal wavelength of green. The blue pixel includes a blue color filter that passes light with a principal wavelength of blue. These color filters are disposed on the major surface of the array substrate 3 or counter-substrate 4.

The liquid crystal display panel 1 includes a connection wiring line group 20, a first connection section 31 and a second connection section 32 on a peripheral part 10 which is located outside the active area 6. The first connection part 31 is connectable to a driving IC chip 11 which functions as a signal supply source that supplies driving signals to the signal supply wiring lines. The second connection part 32 is connectable to a flexible printed circuit (FPC) which functions as a signal supply source. In the example shown in FIG. 1, the first connection part 31 and second connection part 32 are disposed on an extension part 10A of the array substrate 3, which extends outward from an end portion 4A of the counter-substrate 4. The driving IC chip 11 and first connection part 31 are electrically and mechanically connected via, e.g. an anisotropic conductive film.

The driving IC chip 11, which is mounted on the first connection part 31 of the liquid crystal display panel 1, includes at least a part of a signal line driving section 11X which supplies driving signals (video signals) to the signal lines X in the active area 6, and at least a part of a scanning line driving section 11Y which supplies driving signals (scanning signals) to the scanning lines Y in the active area 6.

The connection wiring line group 20 includes a plurality of connection wiring lines which are connected to the signal supply wiring lines, respectively. Specifically, the connection wiring line group 20 includes connection wiring lines W, the number of which is equal to or greater than the number of the signal supply wiring lines. The connection wiring line group 20 includes connection wiring lines WY which are connected to the scanning lines Y, and connection wiring lines WX which are connected to the signal lines X.

With the above-described structure, the scanning line driving section 11Y is electrically connected to the scanning lines Y (1, 2, 3, . . . ) via the connection wiring lines WY. Specifically, driving signals, which are output from the scanning line driving section 11Y, are supplied to the associated scanning lines Y (1, 2, 3, . . . ) via the first connection part 31 and connection wiring lines WY. The switching element 7, which is included in each pixel PX of each row, is controlled ON/OFF by a scanning signal that is supplied from the associated scanning line Y.

The signal line driving section 11X is electrically connected to the signal lines X (1, 2, 3, . . . ) via the connection wiring lines WX. Specifically, driving signals, which are output from the signal line driving section 11X, are supplied to the associated signal lines X (1, 2, 3, . . . ) via the first connection part 31 and connection wiring lines WX. The switching element 7, which is included in each pixel PX of each column, inputs the video signal, which is supplied from the associated signal line X, to the pixel electrode 8 at a timing when the switching element 7 is turned on.

As shown in FIG. 2, the array substrate 3 includes an inspection section 40 for performing an inspection relating to the quality in the active area 6, such as a wiring defect of the connection wiring line group 20, a wiring defect in the active area 6 and the display quality of the pixels PX. The inspection section 40 includes a signal line inspection section 41 that is provided in association with the signal line driving section 11X, a scanning line inspection section 42 that is provided in association with the scanning line driving section 11Y, and a pad section 44 for inputting inspection signals to the inspection sections 41 and 42.

The signal line inspection section 41 includes a signal line inspection driving wiring line 51 which is supplied with an inspection driving signal when the active area 6 is inspected, and which is connected to the respective signal lines X via the connection wiring lines WX of the connection wiring line group 20. In addition, the signal line inspection section 41 includes a switching element 61 between the connection wiring line WX and the signal line inspection driving wiring line 51. Further, the signal line inspection section 41 includes an inspection control wiring line 55 which is supplied with an inspection control signal for controlling ON/OFF of the switching element 61 when the active area 6 is inspected.

The switching element 61 is composed of a thin-film transistor. A gate electrode 61G of each switching element 61 is electrically connected to the inspection control wiring line 55. A source electrode 61S of each switching element 61 is electrically connected to the signal line inspection driving wiring line 51. A drain electrode 61D of each switching element 61 is electrically connected to the signal line X via the associated connection wiring line WX. In short, in the signal line inspection section 41, the inspection control wiring line 55 which is connected to the gate electrode 61G, the signal line inspection driving wiring line 51 which is connected to the source electrode 61S, and the connection wiring line WX which is connected to the drain electrode 61D function as inspection wiring lines to which an inspection signal is supplied when the active area 6 is inspected. The switching element 61 having this structure selectively outputs an inspection signal to the associated signal line X.

The scanning line inspection section 42 includes a scanning line inspection driving wiring line 52 which is supplied with an inspection driving signal when the active area 6 is inspected, and which is connected to the respective scanning lines Y via the connection wiring lines WY of the connection wiring line group 20. In addition, the scanning line inspection section 42 includes a switching element 62 between the connection wiring line WY and the scanning line inspection driving wiring line 52. Further, the scanning line inspection section 42 includes the inspection control wiring line 55 which is supplied with an inspection control signal for controlling ON/OFF of the switching element 62 when the active area 6 is inspected. The inspection control wiring line 55 is common with the signal line inspection section 41.

The switching element 62 is composed of a thin-film transistor. A gate electrode 62G of each switching element 62 is electrically connected to the inspection control wiring line 55. A source electrode 62S of each switching element 62 is electrically connected to the scanning line inspection driving wiring line 52. A drain electrode 62D of each switching element 62 is electrically connected to the scanning line Y via the associated connection wiring line WY. In short, in the scanning line inspection section 42, the inspection control wiring line 55 which is connected to the gate electrode 62G, the scanning line inspection driving wiring line 52 which is connected to the source electrode 62S, and the connection wiring line WY which is connected to the drain electrode 62D function as inspection wiring lines to which an inspection signal is supplied when the active area 6 is inspected. The switching element 62 having this structure selectively outputs an inspection signal to the associated scanning line Y.

The pad section 44 includes an input pad 71 which enables input of an inspection driving signal to one end of the signal line inspection driving wiring line 51, an input pad 72 which enables input of an inspection driving signal to one end of the scanning line inspection driving wiring line 52, and an input pad 75 which enables input of an inspection control signal to one end of the inspection control wiring line 55.

The driving signal that is input from the input pad 71 is an inspection signal which is written in the pixel electrode 8 of each pixel PX at a stage of an inspection. The driving signal that is input from the input pad 72 is an inspection signal for controlling ON/OFF of the switching element 7 of each pixel PX at the stage of the inspection. The control signal that is input from the input pad 75 is an inspection signal for controlling ON/OFF of the switching element 61 of the signal line inspection section 41 and the switching element 62 of the scanning line inspection section 42.

Each of the connection wiring lines WX and WY of the connection wiring line group 20 includes, at an intermediate portion thereof, a connection pad PD which enables connection to the driving IC chip 11.

According to the liquid crystal display device having the above-described structure, it is possible to exactly detect wiring defects on the display panel, such as short-circuit between wiring lines of the connection wiring line group or line breakage of each wiring line, as well as wiring line defects in the active area 6.

The signal line inspection section 41 and scanning line inspection section 42 are disposed on the extension part 10A of the array substrate 3 at a position corresponding to the region where the driving IC chip 11 is disposed. Needless to say, the signal line inspection driving wiring line 51, the scanning line inspection driving wiring line 52 and the inspection control wiring line 55 are disposed on the extension part 10A at a position corresponding to the region where the driving IC chip 11 is disposed. These inspection wiring lines 51, 52 and 55 extend in the longitudinal direction of the driving IC chip 11. Specifically, these inspection wiring lines 51, 52 and 55 overlap the driving IC chip 11 when the driving IC chip 11 is mounted. In short, the inspection wiring lines can be disposed on the array substrate without increasing outside dimensions.

Further, the connection pads PD, which are connectable to the driving IC chip 11, are disposed between the active area 6 and inspection section 40. Thus, the wiring path, through which the inspection signals for performing an inspection relating to the quality in the active area 6, are supplied via the inspection section 40, agrees with the wiring path through which the driving signals (video signal and scanning signal) for displaying an image on the active area 6 are supplied from the driving IC chip 11. Thus, a liquid crystal display device with high reliability can be provided by mounting a driving IC chip 11, which has been determined to be “normal”, on a liquid crystal display panel 1 which has been determined to be “good” by the inspection performed by the inspection section 40.

In the meantime, in the liquid crystal display panel 1 with the above-described structure, the array substrate 3 includes the extension part 10A that extends outward from the end portion 4A of the counter-substrate 4, thereby to enable connection to the driving IC chip 11 and flexible printed circuit (FPC). When the liquid crystal display panel 1 with this shape is formed, there is a concern that when the glass substrate on the counter-substrate 4 side is diced, a diced portion may contact the extension part 10A and may damage the inspection section 40 disposed in the extension part 10A. In addition, in the inspection step, the inspection section 40 may similarly be damaged due to contact of a jig for the inspection, or due to contact of a terminal at a time of repairing the driving IC chip.

The manufacturing yield may deteriorate due to damage to the inspection section 40, for example, breakage of the inspection wiring line, short-circuit between neighboring inspection wiring lines, damage of the switching element, etc.

In the present embodiment, the inspection section 40 includes cover patterns which individually cover at least opposed parts of a first conductive pattern and a second conductive pattern which are spaced apart from each other.

Specifically, as has been described with reference to FIG. 2, the inspection wiring lines 51, 52, 55, WX and WY and the switching elements 61 and 62 are disposed on the inspection section 40. Since the switching elements 61 and 62 have basically the same structure, a specific description is given of the feature of the present embodiment, in particular, on the basis of the switching element 61 and the layout of various inspection wiring lines connected to the switching element 61.

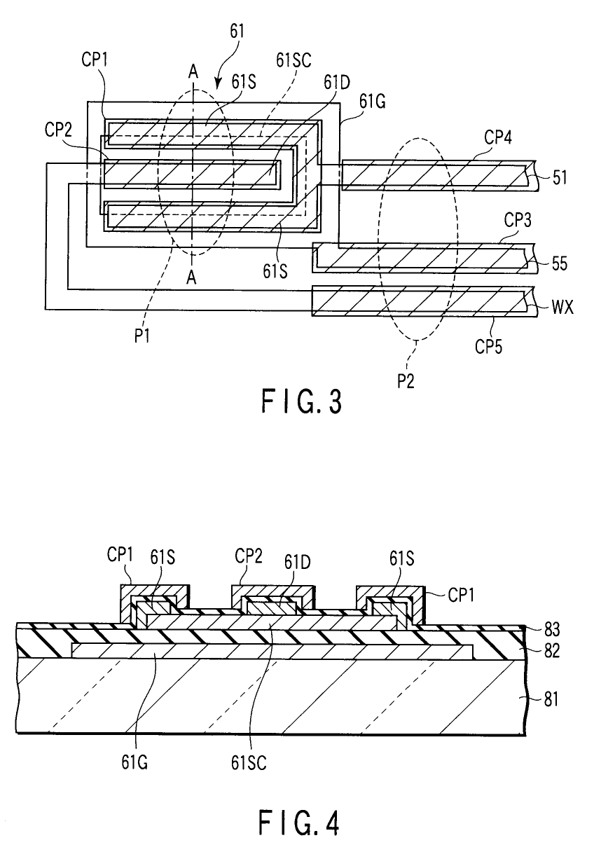

As shown in FIG. 3 and FIG. 4, the gate electrode 61G of the switching element 61 and the inspection control wiring line 55, which is integral with the gate electrode 61G, are formed of, e.g. a stacked body of titanium (Ti)/aluminum (Al)/titanium (Ti), and are disposed on an insulating substrate 81 that constitutes the array substrate 3. The gate electrode 61G and the inspection control wiring line 55 are covered with a first insulation layer 82.

A semiconductor layer 61SC, which constitutes the switching element 61, is formed of, e.g. amorphous silicon and is disposed on the first insulation layer 82. The source electrode 61S and drain electrode 61D of the switching element 61 are formed of, e.g. aluminum (Al) and are disposed on the first insulation layer 82 such that parts of the source electrode 61S and drain electrode 61D are in contact with the semiconductor layer 61SC.

The signal line inspection driving wiring line 51 is formed integral with the source electrode 61S and is disposed on the first insulation layer 82. The connection wiring line WX is formed integral with the drain electrode 61D and is similarly disposed on the first insulation layer 82. The source electrode 61S, drain electrode 61D, signal line inspection driving wiring line 51 and connection wiring line WX are covered with a second insulation layer 83. The first insulation layer 82 and second insulation layer 83 are formed of an inorganic material such as silicon nitride or silicon oxide.

Attention is now paid to a region P1 surrounded by a broken line in FIG. 3. The source electrode 61S corresponds to a first conductive pattern in the inspection section 40, and the drain electrode 61D corresponds to a second conductive pattern in the inspection section 40. The source electrode 61S and drain electrode 61D extend substantially in parallel with a predetermined interval.

The mutually opposed source electrode 61S and drain electrode 61D are covered with individual cover patterns. Specifically, the source electrode 61S is covered with an insular cover pattern CP1. The drain electrode 61D is covered with an insular cover pattern CP2.

Since the conductive patterns which are to be insulated from each other are covered with the individual cover patterns, damage to these conductive patterns can be prevented. Thus, short-circuit between damaged conductive patterns, namely, the source electrode 61S and drain electrode 61D, can be prevented, and the function of the switching element 61 is maintained. Therefore, a decrease in manufacturing yield can be suppressed.

In addition, in the case where the cover patterns CP1 and CP2 are formed of a metallic material, even if the cover patterns CP1 and CP2 are in the conductive state, the source electrode 61S and drain electrode 61D are not directly short-circuited since the second insulation layer 83 is disposed between the source electrode 61S and drain electrode 61D, on the one hand, and the cover patterns CP1 and CP2, on the other hand.

Next, attention is paid to a region P2 surrounded by a broken line in FIG. 3. The inspection control wiring line 55 that is electrically connected to the gate electrode 61G corresponds to the first conductive pattern in the inspection section 40. The signal line inspection driving wiring line 51, which is electrically connected to the source electrode 61S, and the connection wiring line WX, which is electrically connected to the drain electrode 61D, correspond to the second conductive pattern in the inspection section 40. The inspection control wiring line 55, the signal line inspection driving wiring line 51 and the connection wiring line WX extend substantially in parallel with a predetermined interval.

The mutually opposed inspection control wiring line 55, the signal line inspection driving wiring line 51 and the connection wiring line WX are covered with individual cover patterns. Specifically, the inspection control wiring line 55 is covered with an insular cover pattern CP3. Similarly, the signal line inspection driving wiring line 51 and the connection wiring line WX are covered with insular cover patterns CP4 and CP5.

Since the conductive patterns which are to be insulated from each other are covered with the individual cover patterns, damage to these conductive patterns can be prevented. Thus, short-circuit between damaged conductive patterns can be prevented, and the occurrence of breakage of each conductive pattern can be prevented. Therefore, a decrease in manufacturing yield can be suppressed.

In the above-described examples, it is preferable that the cover patterns be formed of a metallic material so that a sufficient hardness can be obtained even with a small film thickness. In particular, it is preferable to form the cover pattern of the same material as the pixel electrode 8. Thereby, the cover patterns and pixel electrodes can be formed in the same fabrication step, and an additional step for forming the cover patterns is needless. Therefore, an increase in manufacturing cost can be suppressed. Further, it is preferable that the cover pattern be formed of ITO which is a metallic material with a higher hardness than the metallic material of the source electrode and drain electrode.

The display device of the present invention is not limited to the above-described liquid crystal display device. The display device may be another kind of display device such as an organic electroluminescence display device having self-luminous elements as display elements.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A display device comprising:
an active area including a plurality of pixels each having a pixel electrode, and a plurality of signal supply wiring lines for supplying driving signals to the pixels; and
an inspection section which is disposed outside the active area and performs an inspection of the active area,
wherein the inspection section includes:
a first conductive pattern;
a second conductive pattern which is spaced apart from the first conductive pattern; and
cover patterns which individually cover at least opposed parts of the first conductive pattern and the second conductive pattern and are formed of the same material as the pixel electrode.

2. The display device according to claim 1, wherein the cover patterns are formed of a material having a higher hardness than a material of which the first conductive pattern and the second conductive pattern are formed.

3. The display device according to claim 1, wherein the cover patterns are formed of indium tin oxide.

4. The display device according to claim 1, wherein the inspection section further includes:
an inspection wiring line to which an inspection signal is supplied when the inspection of the active area is performed; and
a switching element which is composed of a thin-film transistor that is connected to the inspection wiring line and selectively outputs the inspection signal to the signal supply wiring line,
wherein the first conductive pattern is a source electrode of the switching element, and
the second conductive pattern is a drain electrode of the switching element.

5. The display device according to claim 1, wherein the inspection section further includes:
a first inspection wiring line and a second inspection wiring line to which an inspection signal is supplied when the inspection of the active area is performed; and
a switching element which is composed of a thin-film transistor that is connected to the first inspection wiring line and the second inspection wiring line and selectively outputs the inspection signal to the signal supply wiring line,
wherein the first conductive pattern is the first inspection wiring line that is electrically connected to a gate electrode of the switching element, and
the second conductive pattern is the second inspection wiring line that is electrically connected to a source electrode or a drain electrode of the switching element.

6. The display device according to claim 1, wherein the active area is provided in a liquid crystal display panel in which a liquid crystal layer is held between an array substrate and a counter-substrate.

7. The display device according to claim 6, wherein the inspection wiring lines are disposed on an extension part of the array substrate, which extends outward from an end portion of the counter-substrate.

8. The display device according to claim 7, further comprising an IC chip which is disposed at a position corresponding to a region where the inspection wiring lines are disposed.
